(19) United States
(12) Patent Application Publication
(10) Pub. No.: US 2010/0206123 A1
(43) Pub. Date: Aug. 19, 2010

(54) BICYCLE ACCESSORY WITH NON-CLOSING MOUNTS

(76) Inventors: Daniel Dacko, Madison, WI (US); Stephen J. Baumann, Oconomowoc, WI (US)

Correspondence Address: BOYLE FREDRICKSON S.C., 840 North Plankinton Avenue, MILWAUKEE, WI, 53203, US

(21) Appl. No.: 12/370,867

(22) Filed: Feb. 13, 2009

(51) Int. Cl. B62K 21/16; B23P 11/00

(52) U.S. Cl. 74/551.3; 74/551.8; 29/428

(57) ABSTRACT

An electronic bicycle accessory that includes a pair of mounting arms that extend in an opposite direction relative to a display of an electronic device. The pair of mounting arms are oriented in a generally C-shape to define a cavity between the mounting arms. Each mounting arm has a terminal end that extends to an over-center position of the cavity. When the electronic accessory is associated with a bicycle structure, the mounting arms deflect away from one another thereby allowing the bicycle structure to pass into the cavity. Once positioned in the cavity, the mounting arms provide a closure pressure that maintains the orientation of the accessory relative to the bicycle. When removed from a structure, no portion of the accessory remains behind.

### BACKGROUND OF THE INVENTION

The present invention relates generally to bicycle accessories and, more particularly, to a bicycle accessory that cooperates with a bicycle frame structure in a manner that allows the accessory to be quickly and efficiently moved from bicycle to bicycle. The bicycle accessory includes an integrated, generally fixed position, mount arrangement that secures the accessory to the underlying structure.

Interest in recreational and/or competitive cycling continues to increase. The consequence of this popularity of bicycle riding has been a growing presence of bicycle operators or riders or cyclists, of all ages, on public roads or off road trails. Further, as the recreation has grown, typical bicycle excursions or trips have lengthened in extent and, concomitantly a great variety of lighter, multi-geared and faster bicycles have entered the marketplace. Increasingly, as bicycle trips are planned for longer durations and distances, riders commonly prefer to carry several accessories with them during such excursions. One such accessory is commonly referred to as a “computer” that can be further characterized as an electronic device. Understandably, such devices can be relatively compact and configured to provide a variety of information that may be of interest to a rider. Such information can relate to the time of day, calendar information, trip duration, ride performance, rider physical performance data, terrain characteristics, performance comparative data, positional information, etc. It is readily appreciated that such devices can be quickly, conveniently, and economically configured to detect, calculate, display, or communicate such information to a rider or other remote devices.

Many electronic bicycle accessories are configured to be multi-functional and powerful enough that riders often desire to use them for uses that are not necessarily associated with the operation of a specific bicycle. That is, riders occasionally desire to use such devices with more than one particle bicycle such as between a road bike, a mountain bike, and/or a stationary bicycle. Furthermore, many riders desire to remove such devices to prevent theft, protect the device from inclement weather, and/or to simply protect the integrity of the device. Others provide such electronic devices in a two-part form factor wherein an electronic device removably cooperates with a mount assembly. In most of such configurations, the mount assembly remains secured to a bicycle even though the electronic device may be removed therefrom. Unfortunately, such configurations have several undesirable attributes.

Although connecting a mounting assembly to a bicycle allows the rider to quickly and efficiently remove the electronic device from the bicycle, such a configuration limits the use of the electronic device in other applications. That is, to use the electronic device with other bicycles, the user must also remove the mounting assembly or system from the bicycle. Commonly, removing the mounting assembly requires awkward manual manipulation of one or more connection assemblies. Still other mounting assemblies require multiple or specialty tools to remove the mounting assembly from the bicycle. Although such systems provide a mounting arrangement that is less susceptible to inadvertent or unintended loosening and/or removal of the electronic device and/or mounting assembly, such systems have limited applicability beyond use with the bicycle to which the mounting system is affixed. Such devices are ill-equipped for simple and efficient transfer of the desired accessory from one structure of another.

Regardless of the intended use, such accessories must also have some degree of flexibility with respect to interacting with different bicycle structures. That is, regardless of the number of bicycles owned and operated, not all riders prefer the same physical location for such accessories. That is, riders may prefer different locations of the electronic accessory as determined in part by riding conditions, experience, or simply ergonomic preference. Accordingly, it is also desired to provide an electronic accessory that is securable to any of a number of underlying structures.

In view of the above, there exists a need for an improved bicycle electronic accessory that is engageable with a variety of bicycle configurations and components, is constructed such that the electronic accessory can be quickly and efficiently removed from the underlying bicycle and in manner wherein the electronic accessory can be secured to another bicycle, is simple and cost effective to produce, is lightweight, compact, and robust, and is usable across a variety of product platforms.

### SUMMARY OF THE INVENTION

The present invention provides an electronic bicycle accessory that overcomes one or more of the drawbacks discussed above. According to one aspect of the invention, a bicycle accessory is disclosed that includes a pair of mounting arms that extend in an opposite direction relative to a display of an electronic device. The mounting arms are oriented in a generally downward facing C-shape so as to define a cavity between the mounting arms. A distal or terminal end of each mounting arm extends to an over-center position of the cavity. When the electronic accessory is associated with a bicycle structure, the mounting arms deflect away from one another thereby allowing the bicycle structure to pass into the cavity. Once positioned in the cavity, the mounting arms provide a closure pressure that maintains the desired orientation of the accessory relative to the bicycle.

Another aspect of invention useable with one or more of the above aspects discloses an electronic bicycle accessory that includes a body having a cavity formed therein. An electronic device is secured in the cavity. A first arm and a second arm each extend in a cantilevered manner from a side of the body that is generally opposite the cavity. The first arm and the second arm are positioned at generally opposite lateral sides of the body so as to form a mount cavity between the first arm and the second arm. Distal ends of the first and second arms are spaced apart from one another a distance that is less than a greatest distance between the first arm and the second arm so as to retain a bicycle structure that is positioned between the arms.

Another aspect of the invention usable with one or more of the above aspects discloses an electronic bicycle device that has a mount base that includes a clamp portion and which is constructed to support an electronic device. The clamp portion is defined by a pair of arms that extend from the mount base a distance that allows the clamp portion to engage a bicycle structure in an over-center manner. The pair of arms is oriented to apply a clamping force to a bicycle structure positioned therebetween. Preferably, the clamping force is sufficient to maintain the orientation of the mount base during use of a bicycle.

A further aspect of the invention that is combinable with one or more of the above aspects discloses a method of forming an electronic bicycle accessory. A body is formed with a pair of clamp arms. An electronic device is attached to a side of the body that faces in a direction generally opposite the pair of clamp arms. An open gap is formed between the pair of clamp arms and each clamp arm is terminated so that the body snap-fittingly engages a bicycle structure and cooperates with the bicycle structure in a manner that maintains the orientation of the body relative to the bicycle structure when the body is engaged therewith.

Preferably, the arms are constructed so that a display of the electronic device is oriented to align an output with a rider during use of the bicycle. Preferably, the arms engage a handlebar so that a display of the electronic device is oriented generally transverse to a plane that passes though both of the first and second arms. Another preferred aspect of the invention includes configuring the electronic device to communicate with other electronic devices, such as a cadence sensor, associated with the bicycle.

Preferably, another aspect of the invention that is combinable with one or more of the above aspects includes forming the arms in a variety of positions so that a bicycle accessory can be used with bicycles having a variety of constructions.

These and various other features, aspects, and advantages of the present invention will be made apparent from the following descriptions of the drawings.

### BRIEF DESCRIPTION OF THE DRAWINGS

The drawings illustrate one preferred embodiment presently contemplated for carrying out the invention. In the drawings:

FIG. 1 is perspective view of an electronic bicycle accessory according to the present invention engaged with a bicycle structure;

FIG. 2 is a side elevation view of the bicycle accessory shown in FIG. 1;

FIGS. 3-6 are top plan views of the bicycle accessory shown in FIG. 2 and show various outputs that can be displayed therewith;

FIG. 7 is an exploded perspective view of the bicycle accessory shown in FIG. 1;

FIG. 8 is a cross section elevation view of the bicycle accessory taken along line 8-8 shown in FIG. 7; and

FIG. 9 is a cross section elevation view of the bicycle accessory in a plane generally perpendicular to line 9-9 shown in FIG. 7.

### DETAILED DESCRIPTION OF THE PREFERRED EMBODIMENT

FIG. 1 shows an electronic bicycle accessory 10 according to the present invention. In FIG. 1, electronic bicycle accessory 10 is shown engaged with a bicycle structure 11 of an exemplary bicycle 12. Bicycle structure 11 is hereby defined as any structural member of a bicycle such as a handlebar 14. Handlebar 14 of bicycle 12 is rotatably attached to a forward portion 16 of a bicycle frame 18. As is commonly understood, handlebar 14 cooperates with a steerer tube 20 that passes through a head tube 22 of frame 18. Frame 18 includes a top tube 24 and a down tube 26 that extend rearward from head tube 22 toward a seat tube and a crankset, respectively. Forward portion 16 of bicycle 12 is indicative of many different specific application or use bicycles.

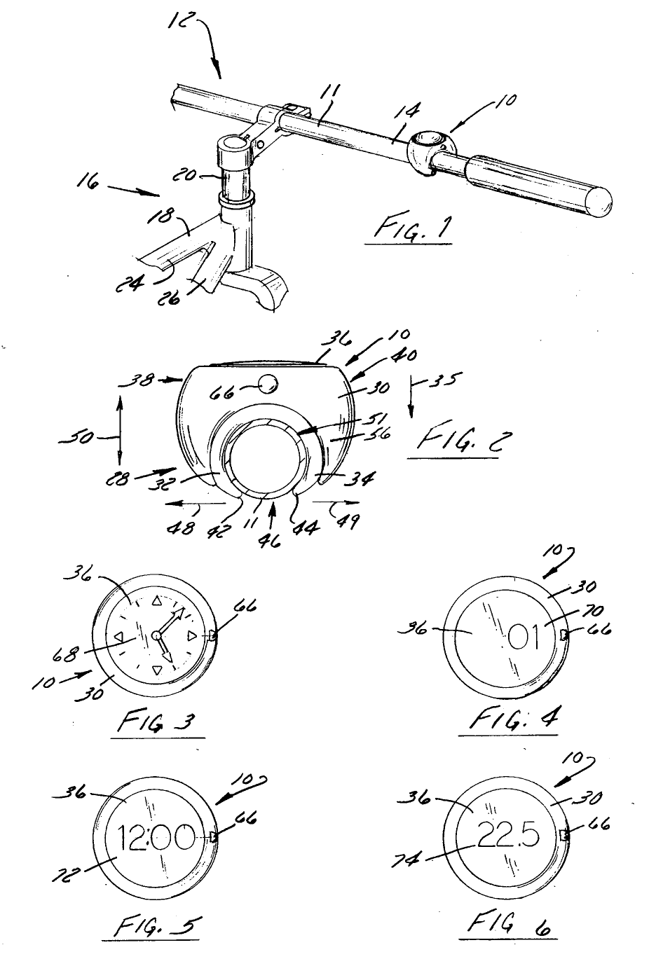

It is appreciated that although electronic accessory 10 is shown engaged with handlebar 14, accessory 10 could be configured to cooperate with portions of frame 18 or bicycle structures 11 that form other portions of the overall bicycle assembly. It is further envisioned that bicycle 12 could be configured in any of what is commonly termed an off-road or mountain bike, a street bike, or a stationary or exercise bicycle. As will be readily understood from the forthcoming description, electronic accessory 10 can be constructed to engage any of a variety of bicycle structures 11. As described further below, it is envisioned that accessory 10 be provided in a number of “sizes” that generally mimic the shape shown in FIGS. 1 and 2 for use with bicycle structures whose cross-section shape is different than that shown. Each of the variable sized accessories 10 is constructed to be quickly and efficiently moved between different bicycles, different support structures, and/or repeatedly removed and engaged with an individual bicycles having similarly sized structures.

Referring to FIG. 2, electronic accessory 10 includes a mount base or body 30. Body 30 includes a clamp portion 28 that is generally defined by a pair of arms; a first arm 32 and a second arm 34. First and second arms 32, 34 extend in a downward direction, indicated by arrow 35, relative to a display or output side 36 of electronic accessory 10. Alternatively, the output of accessory 10 could be oriented nearer or along one of arms 32, 34 rather than being generally centrally positioned relative thereto. First arm 32 and second arm 34 extend from generally opposite ends 38, 40 of body 30 in direction 35. Each arm 32, 34 terminates at a respective distal end 42, 44 that is offset from body 30. That is, each arm 32, 34 extends from body 30 in a cantilevered fashion.

An opening or gap 46 is formed between distal ends 42, 44 of arms 32, 34. Arms 32, 34 and distal ends 42, 44 deflect in respective outward directions, indicated by arrows 48, 49, to allow bicycle structure 11 to pass through gap 46 into a mount cavity 51 between arms 32, 34 when accessory 10 is translated in a direction, indicated by arrow 50, relative to bicycle structure 11. Mount cavity 51 is generally defined as the area encircled or substantially enclosed by arms 32, 34. The gradual deflection of distal ends 42, 44 of arms 32, 34 over bicycle structure 11 provides a snap-fit cooperation of accessory 10 with the respective bicycle structure 11.

As alluded to above, it is envisioned that accessory 10 be provided in different sizes that are generally determined by the size of mount cavity 51. Although arms 32, 34 are generally flexible so as to accommodate some variation in the size and shape of the underlying bicycle structure 11 for which they are intended to cooperate, it is appreciated that some bicycles have fairly large frame tube sizes and comparably small handlebar tubes. It is also appreciated that handlebar tubes are provided in a variety of sizes that may be too great to be accommodated with a single mount cavity size. Accordingly, it is envisioned that accessory 10 be provided in a variety of sizes that are each usable with bicycle structures with a given size range.

Preferably, body 30 is formed of a single material 56 although body 30 could be formed of a variety of layers or portions of different materials. Preferably, body 30 is formed of a more pliable rather than rigid material and is formed via an injection molding process. It is appreciated that body 30 could be formed from any of a number of materials and any of a number of processes. Minimally, body 30 is formed so as to support the electronic device therein and of a material that facilitates the repeated engagement and removal of accessory 10 from an underlying bicycle structure 11.

As described further below, arms 32, 34 cooperate with bicycle structure 11 to preferably maintain a desired position and orientation of body 30 relative to bicycle structure 11. As shown in FIGS. 2-6, an optional but preferred input, such as a switch or input button 66, extends through body 30 and allows a user to interact with the electronic device of electronic bicycle accessory 10. Manipulation of input 66 allows a user to select and/or calibrate various information that can be output on a display oriented proximate output side 36. It is further appreciated that accessory 10 could be provided with more than one input 66.

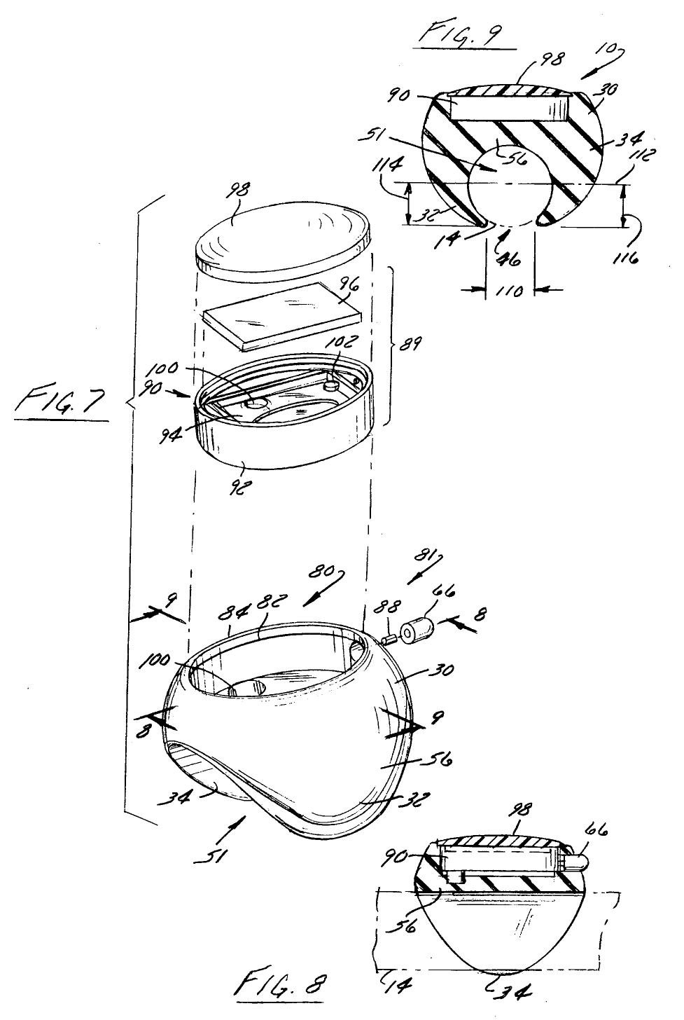

As shown in FIGS. 3-6, it is envisioned that accessory 10 can be configured to output a variety of general and/or exercise related information. As shown in FIG. 3, accessory 10 can be configured to output an analog time 68. Alternatively, as shown in FIG. 4, accessory 10 can output a ride or rider performance time 70. FIG. 5 shows accessory 10 configured to output a digital time display 72 and FIG. 6 shows accessory 10 configured to output a digital date information 74. Those skilled in the art will appreciate that such information is exemplary of only some of the information that accessory 10 can be configured to calculate and/or display. It is further appreciated that accessory 10 could be configured to provide a single output, such as time of day, or a simple timer, for those riders who only desire such limited information in a configuration such as that provided by accessory 10.

FIG. 7 is a perspective view of accessory 10 and shows an electronic device assembly 89 partially exploded therefrom. As shown in FIG. 7, body 30 includes a cavity 80 formed in an upward facing side 81 of body 30 that is generally centrally oriented with respect to the output side 36 of accessory 10. That is, cavity 80 is formed in that side of body 30 that faces in a direction that is generally opposite the direction arms 32, 34 extend from body 30. A lip 82 is formed about a perimeter 84 of cavity 80 and, as described further below, is configured to cooperate with the electronics of accessory 10. An opening 86 is formed through body 30 and fluidly connects cavity 80 to atmosphere. Optional input 66 is configured to cooperate with a pin 88 and opening 86 so as to allow user interaction with an electronic device 90 of accessory 10.

Electronic device 90 includes an optional shell 92 that supports an electronic circuit 94. Optional shell 92 is slidably received within cavity 80 of body 30. Alternatively, cavity 80 could be configured to directly receive electronic circuit 94. A digital, LCD, or LED display 96 is connected to electronic device 90 and generates an output according the configuration of the electronic circuit 94 as discussed above. A cover or lens 98 is disposed over display 96 and cooperates with lip 82 such that electronic device 90 is secured in body 30 in a generally sealed manner.

Still referring to FIG. 7, electronic device 90 includes a battery or other power source 100 that powers operation of the electronic device 90. In a preferred embodiment, electronic device 90 includes a receiver 102 for wirelessly receiving information from other bicycle related electronic devices. One such device, a remote motion detection sensor, is disclosed in applicants copending U.S. Patent Application Publication No. 2008/0252038 and the disclosure of which is incorporated herein. It is further envisioned that receiver 102 be configured to receive information regarding ride performance and/or rider physical performance from such devices as heart rate or pulse monitors equipped with wireless transmission capabilities similar to those disclosed in the above mentioned application publication.

FIGS. 8 and 9 show elevation views of various cross-sections of accessory 10. As indicated in FIG. 7, the views associated with FIGS. 8 and 9 are oriented in planes that are generally perpendicular to one another. As shown in FIG. 8, in a preferred embodiment, display 96 is oriented to generate an output that is generally parallel to handlebar 14. Said in another way, the output of display 96 is oriented in a crossing or transverse direction relative to the orientation of arms 32, 34. Understandably, it is appreciated that if arms 32, 34 are positioned to cooperate with a bicycle structure that is oriented generally transverse to handlebar 14, or structures aligned with a longitudinal axis of a rider during use of a bicycle, such as top tube 24 (FIG. 1), display 96 could be oriented so as to be generally aligned with a plane passing through arms 32, 34 thereby ensuring that the output of display 96 is aligned with a rider during use. Alternatively, it is further envisioned that body 30 be bifurcated so that the output of display 96 can be rotated relative to the axis of arms 32, 34 without separating the respective rotatable portions of the body.

FIG. 9 is an elevation view of a cross-section of accessory 10 taken in a plane generally perpendicular to the view shown in FIG. 8, i.e. a plane that passes through both of arms 32, 34. As shown in FIG. 9, gap 46 has a variable width, indicated by dimension arrow 110, so as to accommodate the passage of bicycle structures 11 of a variety of sizes into mount cavity 51. Preferably, accessory 10 can conveniently cooperate with bicycle structures whose cross sectional shapes only generally correspond to the cross-sectional shape of mount cavity 51. As discussed above, it is envisioned that accessories 10 be provided with arms 32, 34 formed in a number of orientations so that the convenience of accessory 10 can be appreciated across a range of bicycle configurations having differently sized bicycle structures.

Regardless of the specific size of mount cavity 51, distal ends 42, 44 of arms 32, 34 preferably extend beyond a proximate center, indicated by axis 110, of mount cavity 51. That is, arms 32, 34 extend to an over-center position of mount cavity 51. Preferably, distal ends 42, 44 of arms 32, 34 are offset a desired distance, indicated by dimension arrow 114, 116, respectively from center axis 110 of mount cavity 51. Understandably, arms 32, 34 could terminate nearer axis 112 and still maintain a desired orientation of the accessory 10 relative to a respective bicycle structure. Furthermore, although mount cavity 51 is shown as having a generally circular cross-sectional shape, it is envisioned that mount cavity 51 could be provided in any of a number of alternative shapes. That is, it is envisioned that mount cavity 51 could be provided in a variety of shapes and/or sizes to correspond to a shape and/or size of a variety of bicycle structures.

Regardless of the exact size and shape of the bicycle structure, arms 32, 34 are oriented to provide a compression or spring clamp force so as to maintain the desired orientation of body 30 relative to the bicycle structure. That is, accessory 10 cooperates with the underlying structure in a snap-fitting manner and in a manner that does not adversely affect the underlying bicycle structure. Accessory 10 does not include any separable mount hardware that would remain secured to a bicycle after the accessory has been removed therefrom nor does accessory 10 mar or otherwise damage the quality of the surface finish of the bicycle.

The integrity of the surface of the bicycle structure is further protected by material 56. Preferably, material 56 is generally supple, resilient, and/or compliant so as to accommodate variations and/or inconsistencies between the bicycle structure and the mount cavity 51. It is further envisioned that material 56 has a coefficient of friction that contributes to the clamping force associated with the orientation of arms 32, 34 so that the orientation of body 30 can be maintained even with low compression or spring forces being generated by arms 32, 34. Electronic bicycle accessory 10 is self-supporting in that the accessory can be conveniently and efficiently moved between support structures. It is further appreciated that when accessory 10 is removed from a bicycle structure, no trace or indication of the existence of accessory 10 is left behind.

Therefore, an electronic bicycle accessory according to one embodiment of the invention includes a body having a cavity formed therein. An electronic device is secured in the cavity. A first arm and a second arm each extend in a cantilevered manner from a side of the body that is generally opposite the cavity. The first arm and the second arm are positioned at generally opposite lateral sides of the body so as to form a mount cavity between the first arm and the second arm. Distal ends of the first and second arms are spaced apart from one another a distance that is less than a greatest distance between the first arm and the second arm so as to retain a bicycle structure that is positioned between the arms.

Another embodiment of the invention usable with one or more of the features of the above embodiment includes an electronic bicycle device that has a mount base with a clamp portion and which is constructed to support an electronic device. The clamp portion is defined by a pair of arms that extend from the mount base a distance that allows the clamp portion to engage a bicycle structure in an over-center manner. The pair of arms is oriented to apply a clamping force to a bicycle structure positioned therebetween.

A further embodiment of the invention that is combinable with one or more of the above features of the above embodiments includes a method of forming an electronic bicycle accessory. A body is formed with a pair of clamp arms. An electronic device is attached to a side of the body that faces in a direction generally opposite the pair of clamp arms. An open gap is formed between the pair of clamp arms and each clamp arm is terminated so that the body snap-fittingly engages a bicycle structure and cooperates with the bicycle structure in a manner that maintains the orientation of the body relative to the bicycle structure when the body is engaged therewith.

Understandably, the present invention has been described above in terms of the preferred embodiment. It is recognized that various alternatives and modifications may be made to these embodiments which are within the scope of the appending claims.

What is claimed is:

1. An electronic bicycle accessory comprising:
a body;
a cavity formed in the body;
an electronic device secured in the cavity;
a first arm and a second arm that each extend in a cantilevered manner from a side of the body that is generally opposite the cavity, the first arm and the second arm positioned at generally opposite sides of the second side of the body
a mount cavity formed between the first arm and the second arm; and
a distal end of the first arm and a distal end of the second arm being spaced apart from one another a distance that is less than a greatest distance between the first arm and the second arm.

2. The accessory of claim 1 wherein the electronic device includes a display that is oriented generally transverse to a plane that passes though both of the first and second arms.

3. The accessory of claim 1 wherein the body is formed of a material with a coefficient of friction that is high enough to maintain the cavity in an upward orientation when a bicycle structure is positioned in the mount cavity.

4. The accessory of claim 1 wherein the electronic device is configured to communicate with at least other electronic device associated with a bicycle.

5. The accessory of claim 1 further comprising a lip formed about a perimeter of the cavity and configured to maintain the electronic device therein.

6. The accessory of claim 1 wherein at least one of the first arm and the second arm is tapered as it extends from the body toward a respective distal end.

7. The accessory of claim 1 wherein at least one of the first arm and the second arm are deflectable in a direction away from the other of the first arm and the second arm so that a bicycle structure can pass between the distal ends of the first and second arms.

8. An electronic bicycle device comprising:
an electronic device;
a mount base having a clamp portion and being constructed to support the electronic device; and
the clamp portion being defined by a pair of arms that extend from the mount base a distance that allows the clamp portion to engage a bicycle structure in an over-center manner, the pair of arms oriented to apply a clamping force to a bicycle structure positioned therebetween.

9. The device of claim 8 wherein the electronic device and the clamp portion removably engage a bicycle structure without separating.

10. The device of claim 8 wherein a distance between the pair of arms is determined by a handlebar.

11. The device of claim 8 wherein the clamping force is sufficient to maintain the mount base in a desired orientation relative to the handlebar.

12. The device of claim 11 wherein the pair of arms extend about approximately ¾ of a circumference of the handlebar.

13. The device of claim 8 wherein a display of the electronic device is oriented to align an output with a rider during use of the bicycle.

14. The device of claim 13 wherein the output is one of arranged in a longitudinal direction that is generally aligned with a direction of the clamping force and crosses the pair of arms or a longitudinal direction that is generally transverse to a direction of the clamping force.

15. A method of forming an electronic bicycle accessory comprising:
forming a body with a pair of clamp arms;
attaching an electronic device to a side of the body that faces in a direction generally opposite the pair of clamp arms;
forming a open gap between the pair clamp arms; and
terminating each clamp arm so that the body snap-fittingly engages a bicycle structure and cooperates with the bicycle structure in a manner that maintains an orientation of the body relative to the bicycle structure when the body is engaged therewith.

16. The method of claim 15 wherein forming the body further comprises forming the pair of clamp arms at a diameter that is less than a diameter of a bicycle structure with which the electronic bicycle accessory is to cooperate.

17. The method of claim 15 further comprising forming the electronic device to generate more than one output.

18. The method of claim 17 wherein the more than one output includes more than one of a digital time display, an analog time display, a date, a ride distance, and a time of a ride.

19. The method of claim 17 further comprising displaying the more than one output.

20. The method of claim 19 further comprising providing an input to allow a user to switch the display between the more than one output.
